(19) United States
(12) Patent Application Publication
(10) Pub. No.: US 2006/0140518 A1
(43) Pub. Date: Jun. 29, 2006

(54) Ball connect device for a linear guideway

(75) Inventors: Chang-Hsin Kuo, Taichung (TW); Ya-Hui Liao, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/264,838

(22) Filed: Nov. 1, 2005

(30) Foreign Application Priority Data
Dec. 27, 2004 (TW) 093140834

(51) Int. Cl. F16C 19/00

(52) U.S. Cl. 384/51

(57) ABSTRACT

A ball connect device for a linear guideway comprises: at least a ribbon-shaped connecting portion in which being formed a plurality of retaining holes for retaining a plurality of balls, and a plurality ring portions being protruded out a surface of the connecting portion and each of the ring portions being formed around the respective retaining holes to circle around the balls. The ring portions each has two apertures that are located at both sides of the ribbon-shaped connecting portion, a diameter of one of the two apertures is near a diameter of the balls for easy installation of the balls into the ball connect device, and a diameter of another one of the two apertures is smaller than the diameter of the balls so as to prevent disengagement of the balls.

### BACKGROUND OF THE INVENTION

1. Field of the Invention

The present invention relates to a linear gudieway, and more particularly to a ball connect device for a linear guideway.

2. Description of the Prior Art

Two neighboring balls in a linear guideway always rotate in the same direction, that is, the contact portions of the two neighboring balls move in opposite direction relative to each other, this will lead to an increase of the friction and resistance of the linear guideway, and will cause unpleasing noise. To solve these problems, the neighboring balls of a linear guideway are usually separated from one another by a plurality of ball retainers.

Currently, the existing ball retainers generally include two types: the first type of ball retainer is an independent unit, and the second type of ball retainer is an assembly consisted of a plurality of independent units that are connected to one another. The ball retainer 41 consisted of a plurality independent units as shown in FIG. 6 comprises a plurality of partitions 411 connected to one another by a flexible chain 412. The partitions 411 are spaced apart from one another to define a plurality spaces with respect to chain 412 for accommodation of a plurality of balls 30. In production of this type of ball retainer 41, the balls 30 must be placed into the mold in advance, this production method has a strict requirement on the quality of the plastic material and the plastic molding machine, thus relatively increasing the production cost. In addition, this special production method makes the balls 30 come into a very tight contact with the partitions 411 of the retainer 41, accordingly, the rotating resistance of the balls 30 will be relatively large.

The present invention has arisen to mitigate and/or obviate the afore-described disadvantages.

### SUMMARY OF THE INVENTION

The primary objective of the present invention is to provide a ball connect device for a linear guideway that comprises: at least a ribbon-shaped connecting portion in which being formed a plurality of retaining holes for retaining a plurality of balls, and a plurality ring portions being protruded out a surface of the connecting portion and each of the ring portions being formed around the respective retaining holes to circle around the balls. The ring portions each has two apertures that are located at both sides of the ribbon-shaped connecting portion, a diameter D1 of one of the two apertures is near a diameter D of the balls for easy installation of the balls into the ball connect device, and a diameter D2 of another one of the two apertures is smaller than the diameter D of the balls so as to prevent disengagement of the balls.

After studying the elongation of the polymer material and the stress causing the elongation, applicant concludes that the diameter D1 of one of the two apertures is preferably not less than 0.9D (D1≧0.9D). The balls can be easily installed into the ball connect device even when the elongation of diameter D1 is as low as 10%. and to prevent the disengagement of the balls from another aperture, D2 is preferably ≦0.85D, under this condition, only when the elongation D2 is over 15%, the balls will probably disengage from the retaining hole.

The distance between the neighboring balls also can be adjusted appropriately. Each pair of neighboring balls can be connected to each other to reduce the distance between the balls, and thus a ball connect device of the same length can accommodate more balls. On the other hand, neighboring balls can be separated from each other to increase the distance between the balls, and thus the number of ball accommodated by a ball connect device of the same length will be relatively small.

In addition, the connecting portion of the ball connect device in accordance with the present invention can be located in or away from the central axis of the balls, each of the ring portions is an unsymmetrical structure that is located at both sides or at a side of the connecting portion. One of the two apertures of the ring portions can be a flared or tapered aperture.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a top view of showing a ball connect device for a linear guideway;

FIG. 2 is a cross sectional view taken along the line A-A of FIG. 1;

FIG. 3 is a cross sectional view of showing a ball connect device for a linear guideway in accordance with a second embodiment of the present invention;

FIG. 4 is a top view of showing a ball connect device for a linear guideway in accordance with a third embodiment of the present invention; and

FIG. 5 is a cross sectional view taken along the line B-B of FIG. 4.

FIG. 6 is a schematic illustration view of a conventional ball retainer.

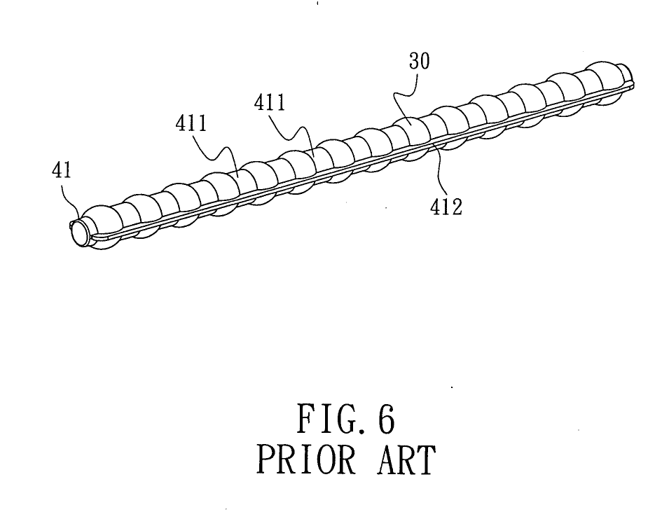

### DETAILED DESCRIPTION OF THE PREFERRED EMBODIMENTS

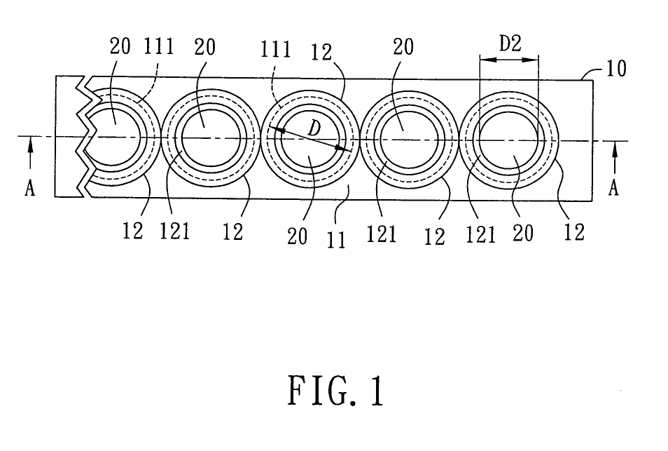

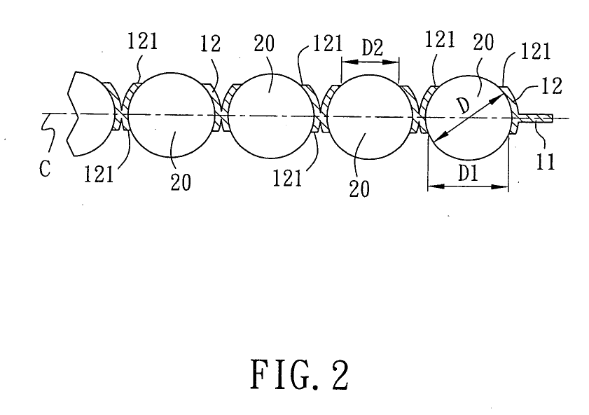

FIG. 1 is a top view of showing a ball connect device for a linear guideway, and FIG. 2 is a cross sectional view taken along the line A-A of FIG. 1. The ball connect device 10 comprise at least a ribbon-shaped connecting portion 11 and a plurality of ring portions 12. The ring portions 12 are connected to one another by the connecting portion 11 and both ends of the ring portions 12 protrude out of the surface of the connecting portion 11, and a plurality of balls 20 are ratably received in a plurality of retaining holes 111 that are longitudinally defined in the ribbon-shaped connecting portion 11. The respective ring portions 12 are formed around the perimeter edge of the retaining holes 111 and serve to circle around and hold the balls 20. Since the ring portions 12 circled around the retaining holes 111 provide assistance to the retaining holes 111 in retaining the balls 20, the balls will be kept firmly in the retaining holes when the ball connect device 10 turns a corner. In this embodiment, the connecting portion 11 is located in the central axis C of the balls 20, so that the center of the balls 20 will approach the connecting portion 11 when the connecting portion 11 bends. Both ends of the respective ring portions 12 are cut to form a flat surface 121 and to make the thickness of the ring portions 12 the same, and the balls 20 partially protrude out of the flat surface 121 at either side of the respective ring portions 12, this arrangement can prevent the interference of the ring portions 12 with respect to the rolling path or the rolling groove in the sliding block. In addition, each of the ring portions 12 is an unsymmetrical structure located at both sides of the connecting portion 11. The ring portions 12 each has two apertures that are located at both sides of the connecting portion 11, the diameter D1 of one of the two apertures is near the diameter D of the balls 20 for easy installation of the balls 20 into the ball connect device 10, and the diameter D2 of another one of the two apertures is smaller than the diameter D of the balls 20 so as to prevent the disengagement of the balls 20 from this aperture.

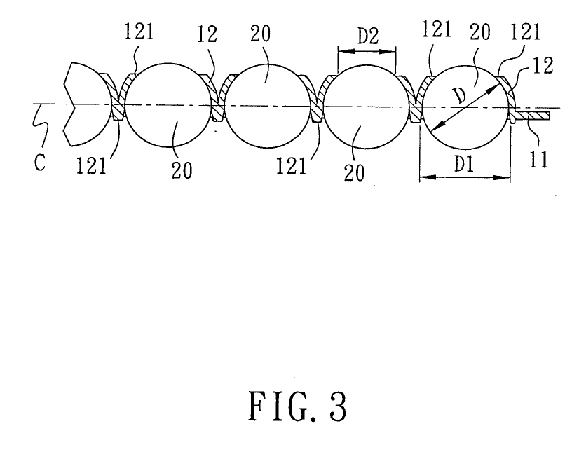

FIG. 3 is a cross sectional view of showing a ball connect device for a linear guideway in accordance with a second embodiment of the present invention. The respective ring portions 12 are also located at both sides of the connecting portion 11 and each pair of neighboring balls 20 are connected to each other, thus reducing the distance between the neighboring balls 20, and accordingly a ball connect device of the same length can accommodate more balls 20. One of the two apertures of the ring portions 12 is a flared aperture and its diameter D1 is larger than the diameter D of the balls 20, and the diameter D2 of another one of the two apertures of the ring portions 12 is smaller than the diameter D of the balls 20, so that the connecting portion 11 is not aligned with the center of the balls and is located at a side of the central axis of the balls 20. Both ends of the respective ring portions 12 are cut to form a flat surface 121 and to make the thickness of the ring portions 12 the same.

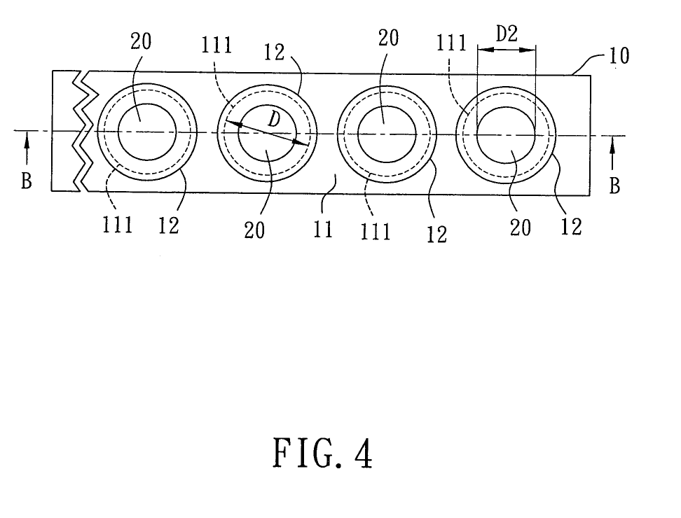

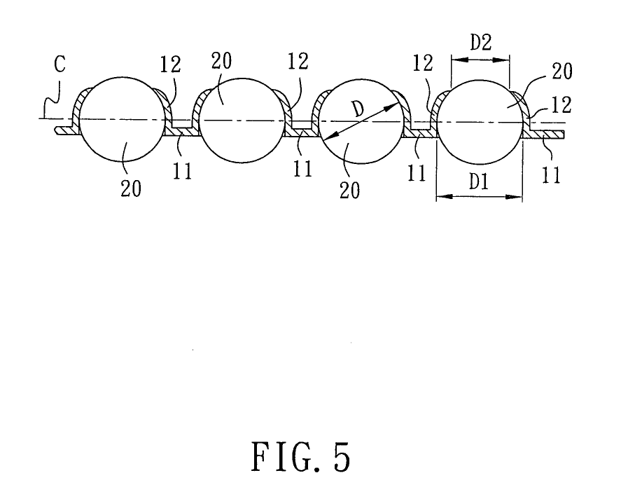

FIG. 4 is a top view of showing a ball connect device for a linear guideway in accordance with a third embodiment of the present invention. FIG. 5 is a cross sectional view taken along the line B-B of FIG. 4. The ball connect device 10 also comprises a ribbon-shaped connecting portion 11 and a plurality of ring portions 12. The ring portions 12 are connected to one another by the connecting portion 11, that is, the ring portions 12 don't contact each other, and a plurality of balls 20 are ratably received in a plurality of retaining holes 111 that are longitudinally defined in the ribbon-shaped connecting portion 11. The respective ring portions 12 are arranged around the perimeter edge of the retaining holes 111 and serve to circle around and hold the balls 20. In this embodiment, the ring portions 12 are located at a side of the connecting portion 11, the diameter of one of the two apertures of the ring portions 12 is equal to the diameter D of the balls 20, and the diameter D2 of another one of the two apertures of the ring portions 12 is smaller than the diameter D of the balls 20. The connecting portion 11 is located at a side of the central axis C of the balls, and the distance between each pair of neighboring balls is relatively large as compared to the previous two embodiments, so that the neighboring ring portions 12 are out of contact with each other. Therefore, the ball connect device 10 of this embodiment has a better bending flexibility.

While we have shown and described various embodiments in accordance with the present invention, it should be clear to those skilled in the art that further embodiments may be made without departing from the scope of the present invention.

What is claimed is:

1. A ball connect device for a linear guideway comprising:
at least a ribbon-shaped connecting portion in which being formed a plurality of retaining holes for retaining a plurality of balls;
a plurality ring portions being protruded out a surface of the connecting portion and each of the ring portions being formed around the respective retaining holes to circle around the balls, wherein the ring portions each has two apertures that are located at both sides of the ribbon-shaped connecting portion, a diameter of one of the two apertures is near a diameter of the balls for easy installation of the balls into the ball connect device, and a diameter of another one of the two apertures is smaller than the diameter of the balls so as to prevent disengagement of the balls.

2. The ball connect device for a linear guideway as claimed in claim 1, wherein the diameter of the balls is D, and the diameters of the two apertures of the ring portions are D1 and D2, D1≧0.9D, and D2≦0.85D.

3. The ball connect device for a linear guideway as claimed in claim 1, wherein the connecting portion is located in a central axis of the balls.

4. The ball connect device for a linear guideway as claimed in claim 2, wherein the connecting portion is located in a central axis of the balls.

5. The ball connect device for a linear guideway as claimed in claim 1, wherein the connecting portion is located at a side of a central axis of the balls.

6. The ball connect device for a linear guideway as claimed in claim 2, wherein the connecting portion is located at a side of a central axis of the balls.

7. The ball connect device for a linear guideway as claimed in claim 1, wherein each of the ring portions is an unsymmetrical structure located at both sides of the connecting portion.

8. The ball connect device for a linear guideway as claimed in claim 2, wherein each of the ring portions is an unsymmetrical structure located at both sides of the connecting portion.

9. The ball connect device for a linear guideway as claimed in claim 1, wherein each of the ring portions is located at a side of the connecting portion.

10. The ball connect device for a linear guideway as claimed in claim 2, wherein each of the ring portions is located at a side of the connecting portion.

11. The ball connect device for a linear guideway as claimed in claim 1, wherein each pair of neighboring ring portions contact each other.

12. The ball connect device for a linear guideway as claimed in claim 2, wherein each pair of neighboring ring portions contact each other.

13. The ball connect device for a linear guideway as claimed in claim 1, wherein each pair of neighboring ring portions don't contact each other.

14. The ball connect device for a linear guideway as claimed in claim 2, wherein each pair of neighboring ring portions don't contact each other.

15. The ball connect device for a linear guideway as claimed in claim 1, wherein a flat surface is formed on each of the ring portions.

16. The ball connect device for a linear guideway as claimed in claim 2, wherein a flat surface is formed on each of the ring portions.

17. The ball connect device for a linear guideway as claimed in claim 1, wherein a diameter of one of the two apertures is equal to the diameter of the balls.

18. The ball connect device for a linear guideway as claimed in claim 2, wherein a diameter of one of the two apertures is equal to the diameter of the balls.
